(19) United States
(12) Patent Application Publication
(10) Pub. No.: US 2017/0053031 A1
(43) Pub. Date: Feb. 23, 2017

(54) INFORMATION FORECAST AND ACQUISITION METHOD BASED ON WEBPAGE LINK PARAMETER ANALYSIS

(71) Applicant: South China University of Technology, Guangzhou City, Guangdong Province (CN)

(72) Inventors: Shoubin DONG, Guangzhou City (CN); Jia CHEN, Guangzhou City (CN); Yue LI, Guangzhou City (CN); Wanrong GU, Guangzhou City (CN); Hua YUAN, Guangzhou City (CN)

(21) Appl. No.: 15/306,777

(22) PCT Filed: Dec. 4, 2014
(86) PCT No.: PCT/CN2014/093070

§ 371 Date: Oct. 26, 2016

(30) Foreign Application Priority Data
Jun. 25, 2014 (CN) 201410290459.X

(51) Int. Cl. G06F 17/30

(52) U.S. Cl. CPC G06F 17/30864; G06F 17/30705; G06F 17/30876

(57) ABSTRACT

The present invention discloses an information prediction and crawling method based on a webpage link parameter analysis, comprising the following sequence of steps: calculating statistical parameter features of webpage links, calculating distribution patterns of outlinks contained in webpages, classifying the webpages according to the distribution patterns of the outlinks of the webpages, performing a sampling prediction on webpage resources, performing an crawling test on prediction samples, and performing an overall prediction on the webpage resources. According to the method of the present invention, the deficiencies of the traditional webpages crawling mode are effectively supplemented, the quantity of link resources to be crawled is expanded, a great number of undiscovered webpage resources are predicted by means of the known webpage resource features, and the speed and coverage rate of the webpage information crawling is improved.

### TECHNICAL FIELD

The present invention relates to the technical field of information crawling required for search engines and Web mining, and particularly to an information prediction and crawling method based on a webpage link parameter analysis.

### BACKGROUND ART

Nowadays, more and more valuable information is provided by the Internet, and people are used to acquiring and locating information by means of search engines. An information crawling system is a core component part of a search engine; and by performing data mining on Web, a large quantity of hidden knowledge on the Web can be discovered, so that various Internet services are derived, and it is also required to deeply acquire webpage information for Web data mining. A general-purpose webpage information crawling system has some limitations:

(I) within a certain crawling depth, some deep webpage data cannot be included;

(II) with the increasingly complex encoding technique of webpages, link resources cannot be extracted therefrom, and a large number of webpage resources are omitted;

and (III) parsing dynamic codes in a webpage based on dynamic web technology such as a JavaScript engine could bring relatively large expenditures to the information crawling system.

The total number of webpages on the Internet continues to increase at a high speed, which proposes a higher requirement for network information crawling system of a search engine. The quantity of webpages of the Internet is very large, especially a rapid increase in the quantity of dynamic webpages. In the process of information crawling, it is unavoidable to encounter various abnormal situations, for example, the problems of a server responding slowly, too many duplicate webpage and invalid webpage links, and difficulty of discovering links between webpage resources, etc. A webpage link is referred to as URL for short.

Therefore, a new network information crawling method is necessary so as to meet the practical requirements.

### SUMMARY OF THE INVENTION

The object of the present invention is to overcome the disadvantages and deficiencies of the prior art, and provide an information prediction and crawling method based on a webpage link parameter analysis, by which clustering and classification decisions are performed on a large number of crawled webpages and link resources, which link resources being further included in a set of unknown webpages is predicted, and in conjunction with the prediction method, more dynamic webpages with similar link can be discovered than that by the traditional crawling methods.

The object of the present invention is achieved through the following technical solutions:

an information prediction and crawling method based on a webpage link parameter analysis, comprising the following sequence of steps:

(1) calculating statistical parameter features of webpage links;

(2) calculating distribution patterns of outlinks contained in webpages, so as to provide features for webpage classification and serve as a basis of recognition;

(3) classifying the webpages according to the distribution patterns of the outlinks of the webpages;

(4) performing a sampling prediction on webpage resources by means of a classification result of and the statistical parameters of the webpage links, so as to generate a small sample for testing the predicted webpage resources;

(5) performing an crawling test on prediction samples obtained by means of sampling, so as to screen out a set of webpage links of which an crawling success rate reaches a self-defined threshold value, and discard part of webpage links which do not comply with a condition;

and (6) performing an overall prediction on the webpage resources: using a result of the sampling test and the statistical parameter features of the webpage links for predicting a set of a great number of valid webpage links.

Step (1) is specifically as follows: by traversing the crawled webpage link base, extracting the parameter features of the webpage links in the process of traverse, and recording a minimum value and a maximum value already occurred in each pair of parameter value pairs.

In step (1), the statistical parameters of the webpage link comprises value information about a parameter part of each webpage link, wherein the parameter part is composed of multiple groups of parameter value pairs, and a pure numerical value part is converted into a value range so as to provide a basis for predicting similar webpage links.

Step (2) is specifically as follows: extracting the outlinks in each webpage, and obtaining distribution patterns of link resources contained on the webpage after clustering.

In step (3), the distribution patterns of the outlinks of the webpages are generated by means of clustering, and all the outlinks of each webpage are aggregated into a plurality of similar form of categories by means of statistical with the same number of prefixes and edit distances within a certain range, and are ranked according to the magnitude of the number of each category so as to obtain the distribution patterns.

In step (3), the webpage classification is used for recognizing the types of the webpage links, which is webpage link of a navigation page, of a list page or of a content page.

In step (4), the sampling prediction of the webpage resources relates to randomly extracting a certain proportion of webpage links under each path of each website from a set of all the webpage resources that can be predicted.

Compared with the prior art, the present invention has the following advantages and beneficial effects:

1. according to the method of the present invention, the deficiencies of the traditional webpage crawling mode are effectively supplemented, the quantity of link resources to be crawled is expanded, a great number of undiscovered webpage resources are predicted by means of the known webpage resource features, and the speed and the coverage rate of the webpage information crawling are improved;

2. in the method of the present invention, the crawling test of the prediction sample can verify whether a predicted webpage link sample corresponding to different parameter values can effectively access network resources, so as to serve as a reference for comprehensively generating predicted webpage link resources in the next step;

and 3. in the method of the present invention, the overall prediction of the webpage resources can eliminate, according to a validity analysis of the sampled prediction sample, a large number of invalid prediction results, reduce the blindness of the prediction, and improve the accuracy.

### BRIEF DESCRIPTION OF THE DRAWINGS

FIG. 1 is a flowchart of an information prediction and crawling method based on a webpage link parameter analysis of the present invention;

FIG. 2 is a basic form diagram of webpage link strings of the method of FIG. 1;

FIG. 3 is a structural schematic diagram of statistical information about already crawled webpage links of the method of FIG. 1;

FIG. 4 is a schematic diagram of the storage of parameter values of different paths in each website of the method of FIG. 1;

FIG. 5 is a schematic diagram of clustering outlinks contained in each webpage of the method of FIG. 1;

FIG. 6 is a schematic diagram of performing classification according to distribution patterns of outlinks of webpages of the method of FIG. 1;

FIG. 7 is a schematic diagram of a webpage link prediction of the method of FIGS. 1; and

FIG. 8 is a schematic diagram of a sampling prediction and an overall prediction of the method of FIG. 1.

### DETAILED DESCRIPTION

The present invention is further described in detail in combination with embodiments and the accompanying drawings below; however, the embodiments of the present invention are not limited thereto.

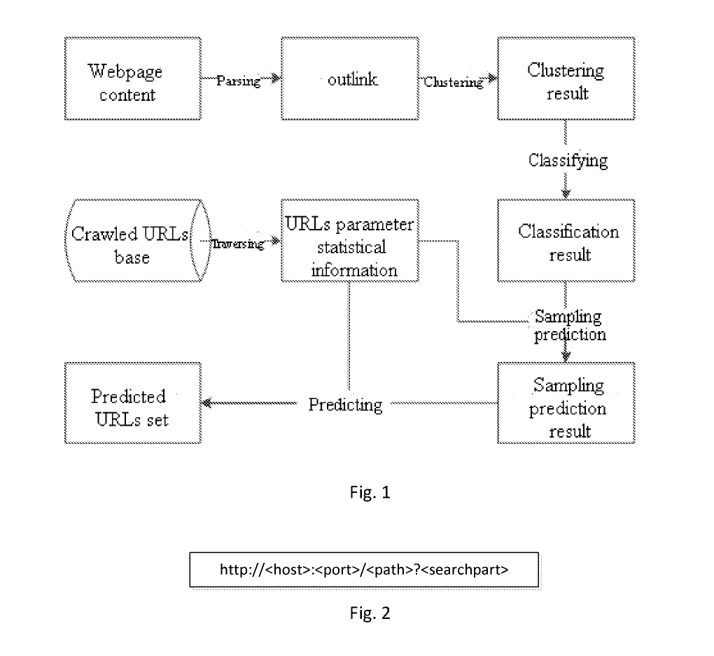

As shown in FIG. 1, an information prediction and crawling method based on a webpage link parameter analysis comprises the following sequence of steps:

(1) statistical parameter features of webpage links is calculated: by traversing the crawled webpage link base, extracting the parameter features of the webpage links in the process of traverse, and recording a minimum value and a maximum value already occurred in each pair of parameter value pairs, wherein

the statistical parameters of the webpage link comprises value information about a parameter part of each webpage link, with the parameter part being composed of multiple groups of parameter value pairs, and a pure numerical value part being converted into a value range so as to provide a basis for predicting similar webpage links.

As shown in FIG. 2, a URL generally comprises two parts: a protocol and a path, <host> representing a site's hostname (a domain name or an IP address), <port> representing a port number, <path> representing a page path, and <searchpart> representing a parameter expression of a GET method; and for a site, only the <path> part can represent a site structure, and the path of a page corresponds to a file system of a Web site, which is also a layered tree structure, with each layer being separated through “/”.

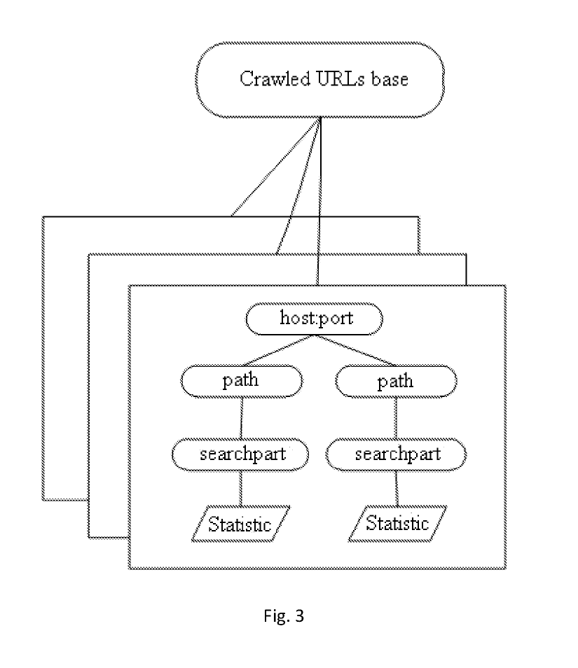

As shown in FIG. 3, a statistical information structure of a crawled URL displays a statistical result obtained after a crawled URL base is traversed, and each website can establish a structure tree corresponding to the website, with a leaf node of the tree storing statistical information under a certain path of the website.

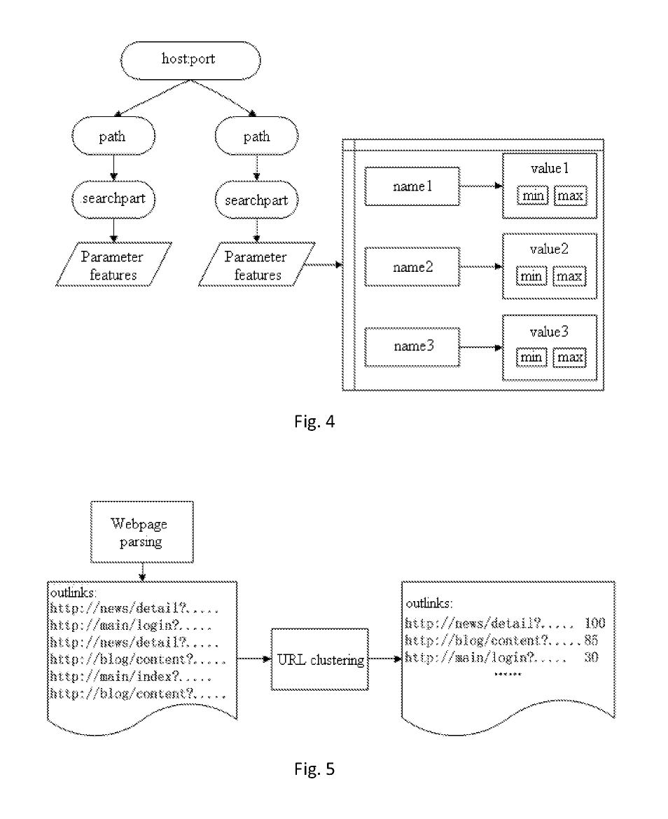

As shown in FIG. 4, the figure displays a schematic diagram of a structure tree of each website, wherein a leaf end of the tree structure stores parameter value pair information extracted from the <searchpart> part of a link, which can be composed of multiple pairs of structure forms (name=value), and the value part stores the ever discovered minimum value and maximum value.

(2) Distribution patterns of outlinks contained in webpages is calculated, so as to provide features for webpage classification and serve as a basis of recognition: extracting the outlinks in each webpage, and obtaining distribution patterns of link resources contained on the webpage after clustering.

As shown in FIG. 5, a webpage parsing module can extract numerous outlinks pointing to external websites from webpage text information, most of the outlinks contained on each webpage are similar in form, a part composed of a site and a path is defined as a prefix, and a clustering module can aggregate the links with the same prefix into one category and calculate the number of the links of the category.

(3) The webpages are classified according to the distribution patterns of the outlinks of the webpages, wherein

the distribution patterns of the outlinks of the webpages are generated by means of clustering, and all the outlinks of each webpage are aggregated into a plurality of categories with a similar form by means of statistical with the same number of prefixes and edit distances within a certain range, and are ranked according to the magnitude of the number of each category so as to obtain the distribution patterns.

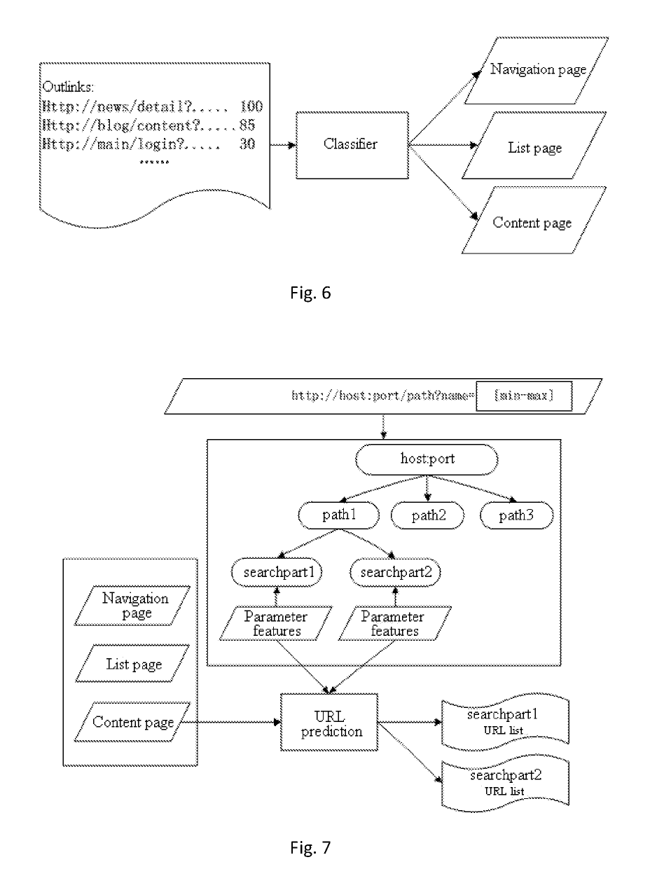

As shown in FIG. 6, the webpage classification is used for recognizing the types of the webpage links, which is webpage link of a navigation page, of a list page or of a content page, wherein

with regard to the navigation page: with a large number of outlinks, after clustering, the feature of the navigation page is that there are multiple categories, wherein the categories with a large number are relatively few and are distributed evenly;

with regard to the list page: with relatively many outlinks, after clustering, the feature of the list page is that the number of the former several large categories accounts for a very large proportion of the total number;

and with regard to the content page: with relatively few outlinks and relatively many characters, the content page can be obtained by means of calculation from a large category of the list page.

(4) A sampling prediction is performed on webpage resources by means of a classification result and the statistical parameters of the webpage links, so as to generate a small sample for testing the prediction webpage resources, wherein

the sampling prediction of the webpage resources relates to randomly extracting a certain proportion of webpage links under each path of each website from a set of all the webpage resources that can be predicted.

As shown in FIG. 7, according to URL statistical information and URL clustering as well as category information obtained by means of classification, prediction extension is performed on a URL form with an extension value, wherein in this step, each prefix composed of <host>:<port>and <path> constitutes a new URL with a parameter value pair (name=value), for example, if the prefix may have three different parameter value pair forms, respectively constructing these thee URLs, and so on; and in the parameters of a URL, there is generally only one key parameter to decide a webpage, which is similar to the function of a major key in a database, and in the following steps, valid parameter value pairs therein can be screened out by means of a sampling test, so as to eliminate a URL constructed by invalid parameter value pairs.

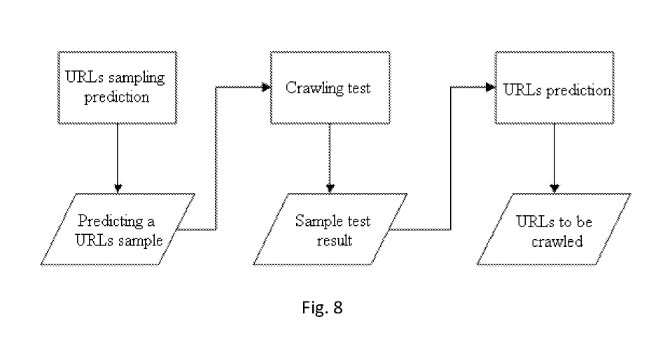

As shown in FIG. 8, in order to prevent too many invalid URL resources from being generated due to a blind prediction, by performing a sampling prediction first and performing an crawling test, the crawling success rate under each path of each website can be counted, and whether the predicted URL is valid can be recognized; and then an overall prediction is performed on a URL set according to the result of the sampling prediction test, and the number of URLs generated by means of sampling is much less than the number of URLs directly generated by means of the overall prediction, and in this manner, the accuracy of the prediction is improved at a relatively small cost.

(5) An crawling test is performed on prediction samples obtained by means of sampling, so as to screen out a set of webpage links of which an crawling success rate reaches a self-defined threshold value, and discard part of webpage links which do not comply with a condition.

(6) An overall prediction is performed on the webpage resources: using a result of the sampling test and the statistical parameter features of the webpage links for predicting a set of a great number of valid webpage links.

The above-mentioned embodiment is a preferred embodiment of the present invention; however, the embodiment of the present invention is not limited by the above-mentioned embodiment, and other any changes, modifications, substitutions, combination and simplification made without departing from the spiritual essence and principle of the present invention should all be equivalent replacement manners and should all fall within the protection scope of the present invention.

1. An information prediction and crawling method based on a webpage link parameter analysis, characterized in that the method comprises the following sequence of steps:
(1) calculating statistical parameter features of webpage links;
(2) calculating distribution patterns of outlinks contained in webpages, so as to provide features for webpage classification and serve as a basis of recognition;
(3) classifying the webpages according to the distribution patterns of the outlinks of the webpages;
(4) performing a sampling prediction on webpage resources by means of a classification result of and the statistical parameters of the webpage links, so as to generate a small sample for testing the predicted webpage resources;
(5) performing an crawling test on prediction samples obtained by means of sampling, so as to screen out a set of webpage links of which an crawling success rate reaches a self-defined threshold value, and discard part of webpage links which do not comply with a condition;
and (6) performing an overall prediction on the webpage resources: using a result of the sampling test and the statistical parameter features of the webpage links for predicting a set of a great number of valid webpage links.

2. The information prediction and crawling method based on a webpage link parameter analysis according to claim 1, characterized in that step (1) is specifically as follows: by traversing a crawled webpage link base, extracting the parameter features of the webpage links in the process of traverse, and recording a minimum value and a maximum value already occurred in each pair of parameter value pairs.

3. The information prediction and crawling method based on a webpage link parameter analysis according to claim 1, characterized in that in step (1), the statistical parameters of the webpage link comprises value information about a parameter part of each webpage link, wherein the parameter part is composed of multiple groups of parameter value pairs, and a pure numerical value part is converted into a value range so as to provide a basis for predicting similar webpage links.

4. The information prediction and crawling method based on a webpage link parameter analysis according to claim 1, characterized in that step (2) is specifically as follows: extracting the outlinks in each webpage, and obtaining distribution patterns of link resources contained on the webpage after clustering.

5. The information prediction and crawling method based on a webpage link parameter analysis according to claim 1, characterized in that in step (3), the distribution patterns of the outlinks of the webpages are generated by means of clustering, and all the outlinks of each webpage are aggregated into a plurality of similar form of categories by means of statistical with the same number of prefixes and edit distances within a certain range, and are ranked according to the magnitude of the number of each category so as to obtain the distribution patterns.

6. The information prediction and crawling method based on a webpage link parameter analysis according to claim 1, characterized in that in step (3), the webpage classification is used for recognizing the types of the webpage links, which is webpage link of a navigation page, of a list page or of a content page.

7. The information prediction and crawling method based on a webpage link parameter analysis according to claim 1, characterized in that in step (4), the sampling prediction of the webpage resources relates to randomly extracting a certain proportion of webpage links under each path of each website from a set of all the webpage resources that can be predicted.
